(19) United States
(12) Patent Application Publication
(10) Pub. No.: US 2026/0024851 A1
(43) Pub. Date: Jan. 22, 2026

(54) BATTERY AND ELECTRONIC DEVICE

(71) Applicant: HUIZHOU LIWINON NEW ENERGY TECHNOLOGY CO., LTD., Huizhou (CN)

(72) Inventors: Wencong LIANG, Huizhou (CN); Biao FENG, Huizhou (CN); Wei PAN, Huizhou (CN); Shengben WU, Huizhou (CN); Jie CHEN, Huizhou (CN)

(21) Appl. No.: 19/342,455

(22) Filed: Sep. 26, 2025

Related U.S. Application Data
(63) Continuation of application No. PCT/CN2024/093945, filed on May 17, 2024.

(30) Foreign Application Priority Data
Apr. 23, 2024 (CN) 202410490875.8

(51) Int. Cl. H01M 50/14; H01M 50/103; H01M 50/176; H01M 50/586; H01M 50/59

(52) U.S. Cl. CPC H01M 50/14; H01M 50/103; H01M 50/176; H01M 50/586; H01M 50/59

(57) ABSTRACT

A battery includes: a housing, including a storage cavity, and opposing first surface and second surface; a terminal, connected to the first surface, where one end of the terminal protrudes from the housing; a cover plate, connected to the housing; a cell, disposed in the storage cavity, where the cell includes a main body and a tab, two ends of the tab are respectively connected to the main body and the terminal, a side of the main body facing away from the tab abuts against the second surface; and a protection member, disposed between the first surface and the cell, where the protection member includes a body portion and a protruding portion connected to and protruding from the body portion, the body portion abuts against the cell, and the protruding portion abuts against the first surface. The battery of the present disclosure can exhibit high safety performance.

### CROSS-REFERENCE TO RELATED APPLICATIONS

This application is a bypass continuation of international application No. PCT/CN2024/093945, filed May 17, 2024, which claims priority to Chinese patent application No. 2024104908758 filed Apr. 23, 2024. The contents of these applications are incorporated herein by reference in their entirety.

### TECHNICAL FIELD

The present disclosure relates to the field of battery technologies, and in particular, to a battery and an electronic device.

### BACKGROUND

In the related art, for a steel-shell battery, after a cell is placed in a shell, a tab needs to be connected to a terminal to establish conductivity between the cell and an external component. The battery needs to undergo a mechanical test to evaluate performance and safety of the battery. The mechanical test includes a drop test, a vibration test, a compression test, and the like. Due to a gap between a side of the cell with the tab and the housing, during the mechanical test of the battery, the cell is prone to pulling on the tab. Consequently, the tab is torn, disconnected, or short-circuited, leading to battery failure.

### SUMMARY

The present disclosure aims to resolve at least one of the technical problems in the existing technology. In view of this, the present disclosure provides a battery that can exhibit high safety performance.

The present disclosure further provides an electronic device.

An embodiment of a first aspect of the present disclosure provides a battery, including:
a housing, including a storage cavity, where the housing includes opposing first surface and second surface;
a terminal, connected to the first surface, where one end of the terminal protrudes from the housing;
a cover plate, connected to the housing;
a cell, disposed in the storage cavity, where the cell includes a main body and a tab, two ends of the tab are respectively connected to the main body and the terminal, and a side of the main body facing away from the tab abuts against the second surface; and
a protection member, disposed between the first surface and the cell, where the protection member includes a body portion and a protruding portion, the protruding portion is connected to the body portion, the protruding portion protrudes from the body portion, the body portion abuts against the cell, and the protruding portion abuts against the first surface.

The battery according to this embodiment of the present disclosure has at least the following beneficial effects: One side of the cell abuts against the second surface of the housing, the other side of the cell abuts against the body portion, and the protruding portion abuts against the first surface. In this way, the two sides of the cell can directly or indirectly abut against the housing by using the protection member. During a mechanical test, for example, a drop test, of the battery, movement space of the cell within the housing is limited. This can effectively prevent the tab from being torn by the main body. Specifically, the battery can exhibit high safety performance.

In accordance with the battery according to some embodiments of the present disclosure, a length of the protection member in a length direction of the cell is B1, and 1 mm≤B1≤4 mm.

In accordance with the battery according to some embodiments of the present disclosure, the length of the protection member in the length direction of the cell is B1, and 1.55 mm≤B1≤3.55 mm.

In accordance with the battery according to some embodiments of the present disclosure, the body portion has a first cavity, the protruding portion has a second cavity, and the first cavity and the second cavity are in communication with each other.

In accordance with the battery according to some embodiments of the present disclosure, a projection of the body portion falls on a projection of the main body in a thickness direction of the protection member.

In accordance with the battery according to some embodiments of the present disclosure, a thickness of the protection member is L1, and 50 μm≤L1≤500 μm.

In accordance with the battery according to some embodiments of the present disclosure, a plurality of protruding portions are provided, and the plurality of protruding portions are arranged at intervals in a length direction of the body portion.

In accordance with the battery according to some embodiments of the present disclosure, a material of the protection member is one of polyetheretherketone, polyimide, polyetheretherketone composite, thermoplastic elastomer, or polyphenylene sulfide.

In accordance with the battery according to some embodiments of the present disclosure, the protection member is made of a material having a Shore hardness≤90 degrees.

In accordance with the battery according to some embodiments of the present disclosure, the protruding portion has an abutment surface, and the abutment surface abuts against the first surface.

In accordance with the battery according to some embodiments of the present disclosure, two protruding portions are provided, the two protruding portions and the body portion jointly define a groove, and the tab is partially disposed in the groove.

In accordance with the battery according to some embodiments of the present disclosure, the housing further includes a third surface, a fourth surface, a first chamfered surface, and a second chamfered surface, the third surface and the fourth surface are oppositely disposed, two ends of the first chamfered surface are connected to the third surface and the first surface respectively, and two ends of the second chamfered surface are connected to the fourth surface and the first surface respectively.

In accordance with the battery according to some embodiments of the present disclosure, the first chamfered surface has a radius of L2, a chamfered portion is disposed at a connection between the body portion and the protruding portion, the chamfered portion has a radius of L3, and 0.1 mm≤L2−L3≤2 mm.

In accordance with the battery according to some embodiments of the present disclosure, a dimension of the protruding portion in a length direction of the cell is L4, and L4≥0.1 mm.

In accordance with the battery according to some embodiments of the present disclosure, the protection member is further provided with a tab hole, a distance between the tab hole and an edge of the protection member in a thickness direction of the battery is L5, and 0.2 mm≤L5≤2 mm.

An embodiment of a second aspect of the present disclosure provides an electronic device, including the battery according to any one of the foregoing embodiments of the first aspect.

The electronic device according to this embodiment of the present disclosure has at least the following beneficial effects: One side of a cell abuts against a second surface of a housing, the other side of the cell abuts against a body portion, and a protruding portion abuts against a first surface. In this way, the two sides of the cell can directly or indirectly abut against the housing by using a protection member. During a mechanical test, for example, a drop test, of the battery, movement space of the cell within the housing is limited. This can effectively prevent the tab from being torn by the main body. Specifically, the battery can exhibit high safety performance. Further, the electronic device including the battery exhibits good safety performance.

Additional aspects and advantages of the present disclosure are given in part in the following description, part of which become apparent from the following description, or are learned from practices of the present disclosure.

### BRIEF DESCRIPTION OF DRAWINGS

The present disclosure is further described below with reference to accompanying drawings and embodiments, where:

FIG. 1 is a schematic diagram of a protection member in a battery according to exemplary embodiments of the present disclosure.

FIG. 2 is a schematic diagram of a protection member in a battery according to exemplary embodiments of the present disclosure.

FIG. 3 is a schematic diagram of a protection member in a battery according to exemplary embodiments of the present disclosure.

FIG. 4 is a schematic diagram of a protection member in a battery according to exemplary embodiments of the present disclosure.

FIG. 5 is a schematic diagram of a battery according to exemplary embodiments of the present disclosure.

FIG. 6 is a schematic diagram of a battery according to exemplary embodiments of the present disclosure.

FIG. 7 is a schematic diagram of a cell in a battery according to exemplary embodiments of the present disclosure.

FIG. 8 is a schematic diagram of a protection member in a battery according to exemplary embodiments of the present disclosure.

FIG. 9 is a schematic diagram of a battery according to exemplary embodiments of the present disclosure.

Reference R numerals:

battery 10; housing 100; storage cavity 110; first surface 120; second surface 130; third surface 140; fourth surface 150; first chamfered surface 160; second chamfered surface 170; protection member 200; body portion 210; protruding portion 220; abutment surface 221; groove 230; chamfered portion 240; flow-through hole 250; tab hole 260; cell 300; terminal 400; cover plate 500; main body 600; tab 700; first cavity 800; and second cavity 900.

### DETAILED DESCRIPTION

Embodiments of the present disclosure will be described in detail hereinafter in conjunction with accompanying drawings in which the same or like reference characters refer to the same or like elements or elements having the same or like functions throughout. The embodiments described below by reference to the accompanying drawings are illustrative and are intended for illustrating only and are not to be construed as limiting the present disclosure.

In the description of the present disclosure, it should be understood that for the description of orientations, the orientation or positional relationships indicated by the terms such as “up,” “down,” “front,” “rear,” “left,” “right” and the like are based on orientation or positional relationships shown in the accompanying drawings, and are used only for ease and brevity of illustration and description, rather than indicating or implying that the mentioned apparatus or element must have a particular orientation or must be constructed and operated in a particular orientation. Therefore, such terms should not be construed as limiting of the present disclosure.

In the description of the embodiments of the present disclosure, the term “at least one” means one or more, the term “plurality of” (or multiple) means at least two, the term such as “greater than”, “less than”, “exceed” or variants thereof prior to a number or series of numbers is understood to not include the number adjacent to the term. The term such as “at least”, “below” and “within” prior to a number or series of numbers is understood to include the number adjacent to the term. If used herein, the terms such as “first,” “second”, and the like are merely used for distinguishing technical features, and are not intended to indicate or imply relative importance, or implicitly point out the number of the indicated technical features, or implicitly point out the precedence order of the indicated technical features.

In the description of the present disclosure, unless otherwise explicitly defined, the terms such as “configure,” “install/mount” and “connect” should be understood in a broad sense, and those having ordinary skills in the art can reasonably determine the specific meanings of the above terms in the present disclosure based on the specific contents of the technical scheme.

In the description of the specification, the description with reference to the terms “an embodiment,” “some embodiments,” “illustrative embodiments,” “example,” “specific example,” or “some examples” and so on means that specific features, structures, materials or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments.

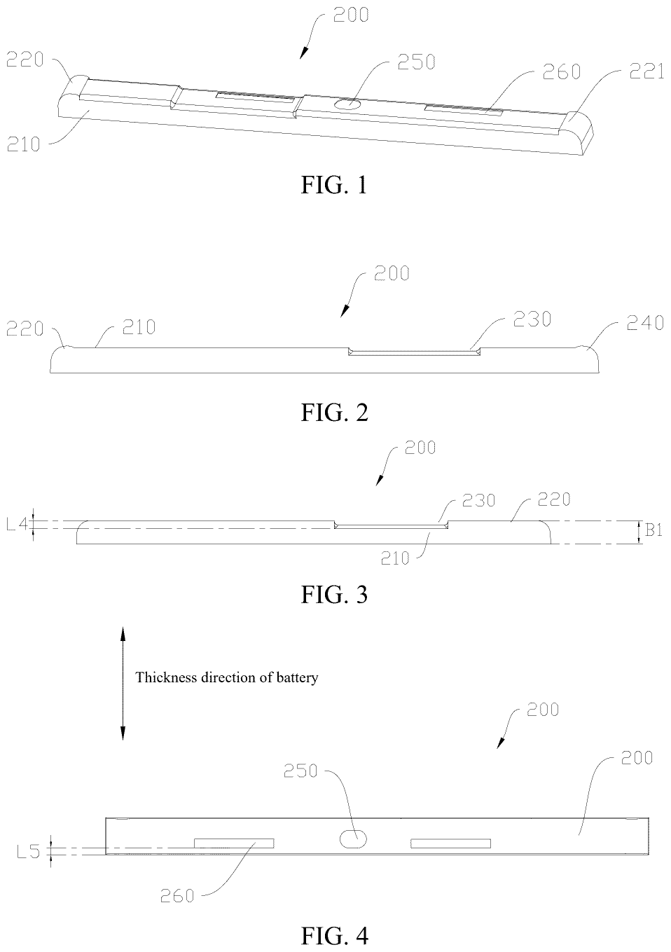

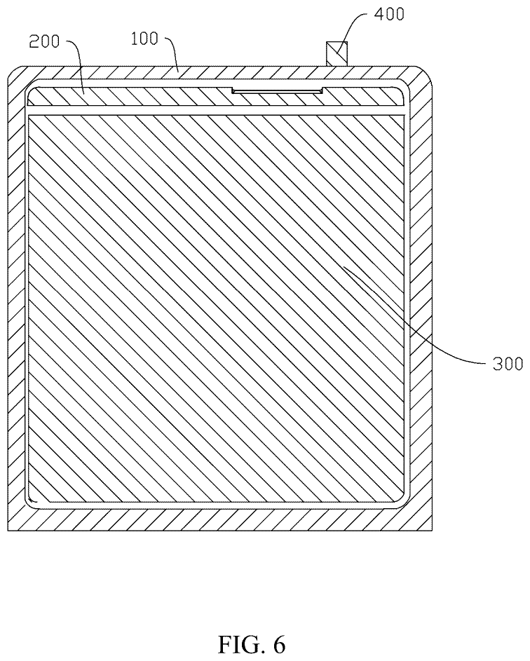

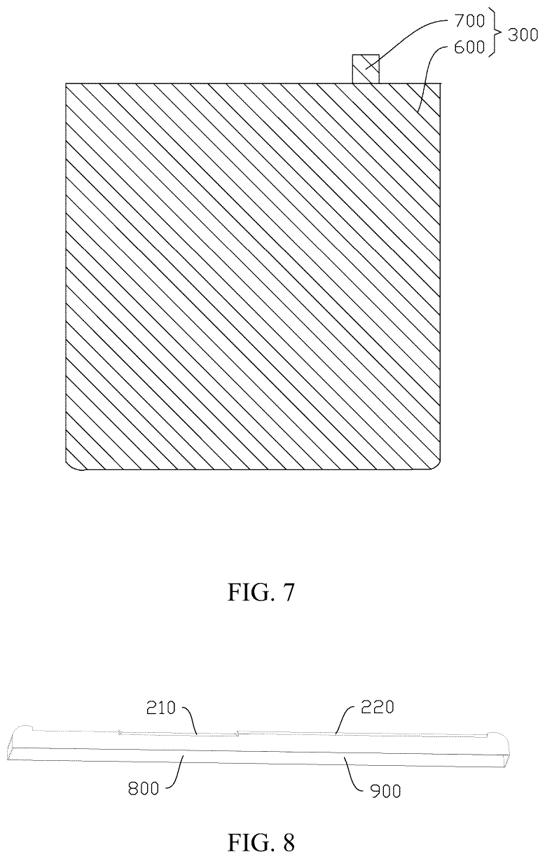

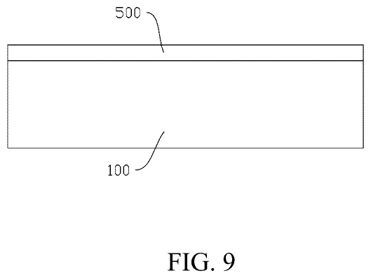

Refer to FIG. 1 to FIG. 9. In some embodiments, a battery 10 includes: a housing 100, a terminal 400, a cover plate 500, a cell 300, and a protection member 200. The housing 100 includes a storage cavity 110, where the housing 100 includes opposing first surface 120 and second surface 130. The housing 100 may be rectangular. The housing 100 includes the opposing first surface 120 and second surface 130, opposing third surface 140 and fourth surface 150, and a fifth surface. The first surface 120, the second surface 130, the third surface 140, and the fourth surface 150 are all arranged around and connected to the fifth surface, thereby forming the storage cavity 110. After the cover plate 500 is connected to the housing 100, the cover plate 500 seals an opening of the storage cavity 110. It should be supplemented that, after the cover plate 500 is connected to the storage cavity 110, the cover plate 500 becomes a sixth surface of the housing 100. Both the fifth surface and the sixth surface are surfaces having the largest area in the housing 100. The terminal 400 is connected to the first surface 120, and one end of the terminal 400 protrudes from the housing 100. The terminal 400 may include a positive terminal and a negative terminal, and the positive terminal and the negative terminal may serve to establish conductivity between the cell 300 and an external component. The cover plate 500 is connected to the housing 100. Specifically, the cover plate 500 may be connected to the housing 100 by welding. In other words, the cover plate 500 may be connected to the housing 100 by welding. The cell 300 is disposed in the storage cavity 110. The cell 300 includes a main body 600 and a tab 700, two ends of the tab 700 are respectively connected to the main body 600 and the terminal 400, and a side of the main body 600 facing away from the tab 700 abuts against the second surface 130. The protection member 200 is disposed between the first surface 120 and the cell 300, where the protection member 200 includes a body portion 210 and a protruding portion 220, the protruding portion 220 is connected to the body portion 210, the protruding portion 220 protrudes from the body portion 210, the body portion 210 abuts against the cell 300, and the protruding portion 220 abuts against the first surface 120.

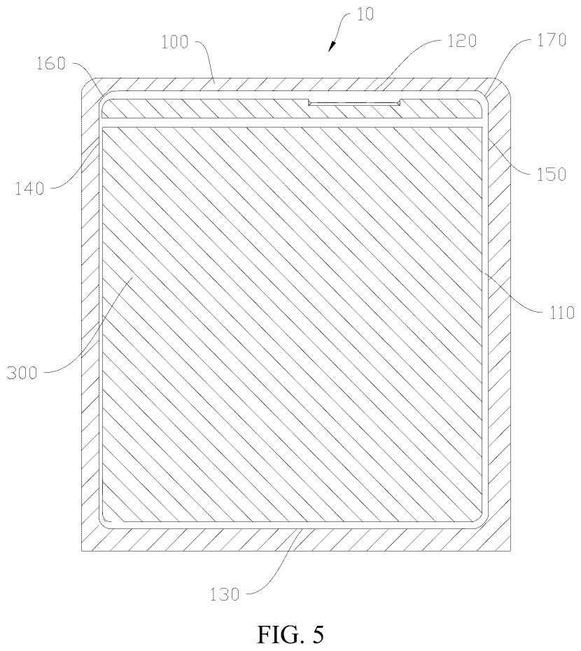

Specifically, refer to FIG. 5. In FIG. 5, to facilitate observation of the cell 300, the protection member 200, and the housing 100, the cell 300 is not in contact with the protection member 200 and the housing 100. One side of the cell 300 abuts against the second surface 130 of the housing 100, the other side of the cell 300 abuts against the body portion 210, and the protruding portion 220 abuts against the first surface 120. In this way, the two sides of the cell 300 can directly or indirectly abut against the housing 100 by using the protection member 200. During a mechanical test, for example, a drop test, of the battery 10, movement space of the cell 300 within the housing 100 is limited. This can effectively prevent the tab from being torn by the main body. Specifically, the battery 10 can exhibit high safety performance.

It should be supplemented that, in the existing technology, after the cell 300 is placed in the storage cavity 110, a certain space is reserved between the cell 300 and the housing 100 to facilitate welding of the tab 700 and the terminal 400. After the tab 700 and the terminal 400 are welded, due to a gap between the cell 300 and the housing 100, when the battery 10 is dropped, the main body 600 of the cell 300 moves within the storage cavity 110, causing the main body 600 to pull on the tab 700. Consequently, the tab 700 is torn or the tab 700 and the terminal 400 are disconnected. In the present disclosure, after the protection member 200 is disposed, a large gap between the main body 600 of the cell 300 and the housing 100 can be effectively avoided. Further, configuration in which the body portion 210 of the protection member 200 abuts against the cell 300 and the protruding portion 220 abuts against the first surface 120 can effectively prevent the main body 600 of the cell 300 from moving within the storage cavity 110, thereby avoiding damage to the tab 700. In addition, during a mechanical test of the battery 10, the protection member 200 can also absorb most of the impact force, thereby effectively avoiding damage caused when the main body 600 of the cell 300 comes into contact with the housing 100. Moreover, a material of the protection member 200 may be an insulating material, so that the protection member 200 can further effectively avoid short circuiting of the battery 10.

Further, refer to FIG. 3. In some embodiments, a length of the protection member 200 in a length direction of the cell 300 is B1, and 1 mm≤B1≤4 mm. Specifically, the length of the protection member 200 may be 1 mm, 1.15 mm, 1.2 mm, 1.55 mm, 1.95 mm, 2.0 mm, 2.35 mm, 2.5 mm, 2.75 mm, 3.15 mm, 3.5 mm, or 4 mm. When the length of the protection member 200 is less than 1 mm, drop resistance performance of the battery 10 is poor, and the protection member 200 cannot provide a good protective effect. When the length of the protection member 200 is greater than 4 mm, a volume of the protection member 200 is large, leading to excessive material waste and excessive costs. In addition, the excessive length of the protection member 200 may cause the protection member 200 to damage the cell 300. Specifically, descriptions are given below with reference to experimental data. A plurality of identical bare cells 300 and housings 100 were prepared, and lengths of protection members 200 were 0.95 mm, 1 mm, 1.55 mm, 1.95 mm, 2.35 mm, 2.75 mm, 3.15 mm, 3.55 mm, 3.65 mm, and 4 mm, respectively. Subsequently, protection members 200 of different sizes were installed in the housings 100, and then the cell 300 was fully charged, and a directional drop (where six surfaces of the battery 10 and four corners of the battery 10 were respectively oriented toward and dropped onto a marble floor at a height of one meter during the drop, which constituted one round of test) limit test was conducted, until the drop failed. If no failure occurred after five rounds, the test was considered passed. For details, refer to Table 1 and Table 2 below.

TABLE 1

| | |
|---|---|
| Comparative Example 1 | No protection member 200 |
| | installed |
| Comparative Example 2 | Protection member 200 with a |
| | height of 0.95 mm installed |
| Comparative Example 3 | Protection member 200 with a |
| | height of 4.15 mm installed |
| Embodiment 1 | Protection member 200 with a |
| | height of 1 mm installed |
| Embodiment 2 | Protection member 200 with a |
| | height of 1.55 mm installed |
| Embodiment 3 | Protection member 200 with a |
| | height of 1.95 mm installed |
| Embodiment 4 | Protection member 200 with a |
| | height of 2.35 mm installed |
| Embodiment 5 | Protection member 200 with a |
| | height of 2.75 mm installed |
| Embodiment 6 | Protection member 200 with a |
| | height of 3.15 mm installed |
| Embodiment 7 | Protection member 200 with a |
| | height of 3.55 mm installed |
| Embodiment 8 | Protection member 200 with a |
| | height of 4 mm installed |

TABLE 2

| | |
|---|---|
| Comparative Example 1 | Failed after 1 round |
| Comparative Example 2 | Failed after 2 rounds |
| Comparative Example 3 | Failed after 2 rounds |
| Embodiment 1 | Failed after 7 rounds |
| Embodiment 2 | Failed after 6 rounds |
| Embodiment 3 | Failed after 6 rounds |
| Embodiment 4 | Failed after 7 rounds |
| Embodiment 5 | Failed after 6 rounds |
| Embodiment 6 | Failed after 6 rounds |
| Embodiment 7 | Failed after 6 rounds |
| Embodiment 8 | Failed after 6 rounds |

To summarize the tables described above, a pass criterion for the directional drop was set at five rounds. Therefore. Embodiments 1, 2, 3, 4, 5, 6, 7, and 8 all passed the test. In Comparative Example 1, due to absence of the protection member 200, the tab 700 was prone to coming into contact with the housing 100, causing short circuiting. In Comparative Example 2, due to the excessively short protection member 200, the protection member 200 could not effectively protect a positive tab after dropping, resulting in failure caused by short circuiting. In Comparative Example 3, due to the excessively long protection member 200, costs were excessively high and the cell 300 was damaged.

Further, the length of the protection member 200 is specified as described above, so that the protection member 200 provides a good protective effect. In a process of installing the protection member 200 into the housing 100, the ease of installation of the protection member 200 affects installation efficiency of an operator. To facilitate the installation of the protection member 200, the length of the protection member 200 may be further specified. Specifically, in some embodiments, the length of the protection member 200 in the length direction of the cell 300 is B1, and 1.55 mm≤B1≤3.55 mm. Specifically, the length of the protection member 200 may be 1.55 mm, 1.95 mm, 2.0 mm, 2.35 mm, 2.5 mm, 2.75 mm, 3.15 mm, or 3.55 mm. When the length of the protection member 200 is less than 1.55 mm, the protection member 200 is difficult to install, resulting in a low installation yield rate. When the length of the protection member 200 is greater than 3.55 mm, the protection member 200 is easy to install, but the length of the protection member 200 is still excessively long, causing the protection member 200 to occupy excessive space of the housing 100. Consequently, a size of the cell 300 in the housing 100 is reduced, and an energy density of the battery 10 is low. That is, the protection member 200 is easy to install, but the energy density of the battery 10 is low. Explanations are given below through experiments. For details, refer to the table below.

TABLE 3

| | |
|---|---|
| Comparative | No installation required (no protection |
| Example 1 | member 200) |
| Comparative | <10% yield rate (protection member |
| Example 2 | with a length of 1.05 mm) |
| Comparative | >99% yield rate (protection member |
| Example 3 | with a length of 3.65 mm) |
| Comparative | <10% yield rate (protection member |
| Example 4 | with a length of 1.15 mm) |
| Embodiment 1 | Approximately 40% yield rate |
| | (protection member with a length of |
| | 1.55 mm) |
| Embodiment 2 | Approximately 60% yield rate |
| | (protection member with a length of |
| | 1.95 mm) |
| Embodiment 3 | >99% yield rate (protection member |
| | with a length of 2.35 mm) |
| Embodiment 4 | >99% yield rate (protection member |
| | with a length of 3.15 mm) |
| Embodiment 5 | >99% yield rate (protection member |
| | with a length of 3.55 mm) |

In summary, when the length of the protection member 200 was greater than 1.55 mm, a greater length of the protection member 200 facilitated easier installation. The length of the protection member 200 should not exceed 3.55 mm, because this led to a low energy density of the battery 10.

Further, refer to FIG. 8, in some embodiments, the body portion 210 has a first cavity 800, the protruding portion 220 has a second cavity 900, and the first cavity 800 and the second cavity 900 are in communication with each other. Specifically, by providing the body portion 210 with the first cavity 800 and the protruding portion 220 with the second cavity 900, the protection member 200 can form a hollow structure. In a first aspect, after the body portion 210 is provided with the first cavity 800 and the protruding portion 220 is provided with the second cavity 900, a weight of the protection member 200 may be reduced, thereby indirectly reducing a weight of the battery 10, so that the battery 10 is lightweight. In a second aspect, after the body portion 210 is provided with the first cavity 800 and the protruding portion 220 is provided with the second cavity 900, the protection member 200 may further have good elasticity while the protection member 200 achieves good support, so that the protection member 200 deforms upon impact, thereby effectively preventing the protection member 200 from damaging the cell 300.

Further, there are two manners in which the body portion 210 of the protection member 200 abuts against the cell 300. In one manner, the protection member 200 is sleeved over the main body 600, and in another manner, the protection member 200 is not sleeved over the main body 600. The first manner is described below. In some embodiments, the cell 300 is partially disposed in the first cavity 800. Specifically, a specific manner in which the protection member 200 is sleeved over the main body 600 is that the first cavity 800 is sleeved over the main body 600. This configuration can reduce a volume occupied by the protection member 200 in the housing 100, and enable the cell 300 to occupy more volume, so that the battery 10 has a higher energy density.

The second manner is described below. In some embodiments, a projection of the body portion 210 falls on a projection of the main body 600 in a thickness direction of the protection member 200. Specifically, in this manner, a cross-sectional area of the protection member 200 is smaller than a cross-sectional area of the main body 600, and one end of the body portion 210 abuts against the main body 600. Configuration in which one end of the body portion 210 facing away from the protruding portion 220 abuts against the main body 600 can effectively avoid a problem of an excessively large thickness of the cell 300. Specifically, after the protection member 200 is sleeved over the main body 600, a final thickness of the cell 300 is a thickness of the protection member 200 plus a thickness of the main body 600. This increases a final thickness of the battery 10, resulting in a low energy density of the battery 10.

Further, in some embodiments, a thickness of the protection member 200 is L1, and 50 μm≤L1≤500 μm. For example, the thickness of the protection member 200 may be 50 μm, 60 μm, 100 μm, 200 μm, 300 μm, or 500 μm. When the thickness of the protection member 200 is less than 50 μm, the thin protection member 200 leads to high processing difficulty, resulting in excessively high manufacturing costs of the protection member 200. Moreover, the thin protection member 200 leads to a poor support performance and a poor cushioning effect of the protection member 200. When the thickness of the protection member 200 is greater than 500 μm, the large thickness of the protection member 200 also leads to large manufacturing difficulty of the protection member 200. In addition, the large thickness of the protection member 200 further leads to additional material waste.

Specifically, the protruding portion 220 may abut against the first surface 120, to effectively absorb an impact force. It is conceivable that a plurality of protruding portions 220 may be provided to improve the cushioning performance. Therefore, refer to FIG. 1. In some embodiments, a plurality of protruding portions 220 are provided, and the plurality of protruding portions 220 are arranged at intervals in a length direction of the body portion 210. Specifically, there may be two, three, or four protruding portions 220, and the two protruding portions 220 respectively abut against two ends of the first surface 120, so that the protruding portions 220 provide a good cushioning effect and protect the tab from being damaged. In addition, the plurality of protruding portions 220 may have a larger contact area with the first surface 120, thereby effectively distributing an impact force received by various positions of the main body 600.

Further, in some embodiments, a material of the protection member 200 is one of polyetheretherketone, polyimide, polyetheretherketone composite, thermoplastic elastomer, or polyphenylene sulfide. Polyetheretherketone (PEEK) is a high-performance thermoplastic material, which has certain elasticity, and can deform within a specific range and return to its original shape after an external force is removed. Polyimide (PI) is a specialty engineering material with excellent high temperature resistance. Polyetheretherketone composite uses polyetheretherketone resin as a matrix and is reinforced by adding another material, for example, fiber. Because the matrix material PEEK has certain elasticity, the composite also has specific elastic characteristics. Thermoplastic elastomer (TPE) not only has high elasticity of traditional cross-linked vulcanized rubber, but also has characteristics of convenient processing of conventional plastic. Thermoplastic elastomer has significant elastic characteristics, and can freely deform within a specific range and return to its original shape. Polyphenylene sulfide (PPS) also has certain elasticity. Specifically, when the material of the protection member 200 is one of the foregoing materials, the protection member 200 has good elasticity, so that the protection member 200 can absorb an impact force caused by movement of the main body 600, thereby providing cushioning, and effectively protecting the tab 700. In addition, all of the foregoing materials have a characteristic of high temperature resistance. Because the cell 300 generates heat during charging and discharging, the high temperature resistance property can also contribute to an extended service life of the protection member 200.

Further, the protection member 200 is made of a material having a Shore hardness≤90 degrees. If the Shore hardness of the protection member 200 is greater than 90 degrees, when the protection member 200 is dropped, the protection member 200 may puncture the cell 300 due to excessive hardness, resulting in damage to the cell 300. The Shore hardness of the protection member 200 may be 30 degrees, 40 degrees, 50 degrees, 60 degrees, 70 degrees, 80 degrees, or 90 degrees.

Further, when the protruding portion 220 abuts against the first surface 120, the protruding portion 220 may be in line-surface contact with the first surface 120 (where the protruding portion 220 may be as shown in FIG. 1), that is, a shape of the protruding portion 220 may be circular. The protruding portion 220 may be in surface contact with the first surface 120 (where the protruding portion 220 may be as shown in FIG. 3), and a surface of the protruding portion 220 may be planar. Specifically, refer to FIG. 3. In some embodiments, the protruding portion 220 has an abutment surface 221, and the abutment surface 221 abuts against the first surface 120. Specifically, the abutment surface 221 may be planar, and the first surface 120 may also be planar. When the two planar surfaces abut against each other, there is a large contact area between the protruding portion 220 and the first surface 120, allowing the protruding portion 220 to uniformly distribute an impact force from the main body 600.

Further, it is conceivable that the protection member 200 needs to be provided with a groove 230 to reserve space, thereby facilitating welding of the tab 700 to the terminal 400 by the operator. Specifically, the groove 230 may be defined by two protruding portions 220 and the body portion 210. To be specific, refer to FIG. 2 and FIG. 3. In some embodiments, two protruding portions 220 are provided, the two protruding portions 220 and the body portion 210 jointly define a groove 230, and the tab is partially disposed in the groove 230. A through hole is provided on the groove 230, the through hole may allow the tab to pass through, and the tab is welded to the terminal after the tab passes through the through hole. The welding of the tab to the terminal may be direct welding or indirect welding, and the indirect welding is to weld the tab and the terminal respectively through a connecting piece. When the tab and the terminal are respectively connected by the connecting piece, a width of the connecting piece is larger than a width of the groove 230. In addition, the two protruding portions 220 may all abut against the first surface 120, so that the protection member 200 uniformly distributes an impact force from the main body. It is conceivable that an additional through hole may be provided on the protruding portion 220 for a negative tab to pass through.

Further, refer to FIG. 5. In some embodiments, the housing 100 further includes a third surface 140, a fourth surface 150, a first chamfered surface 160, and a second chamfered surface 170, the third surface 140 and the fourth surface 150 are oppositely disposed, two ends of the first chamfered surface 160 are connected to the third surface 140 and the first surface 120 respectively, and two ends of the second chamfered surface 170 are connected to the fourth surface 150 and the first surface 120 respectively. Specifically, the first chamfered surface 160 may be formed by performing chamfering at a connection between the first surface 120 and the third surface 140, and the second chamfered surface 170 may be formed by performing chamfering at a connection between the second surface 130 and the fourth surface 150. Configuration of the first chamfered surface 160 and the second chamfered surface 170 can make the housing 100 more rounded, thereby effectively preventing the housing 100 from injuring a user. In addition, the configuration of the first chamfered surface 160 and the second chamfered surface 170 can further facilitate processing and manufacturing of the housing 100 by the operator.

Further, in some embodiments, the first chamfered surface 160 has a radius of L2, a chamfered portion 240 is disposed at a connection between the body portion 210 and the protruding portion 220, the chamfered portion 240 has a radius of L3, and 0.1 mm≤L2−L3≤2 mm. Specifically, L2−L3 may be equal to 0.1 mm, 0.5 mm, 1 mm, or 2 mm. When a difference between the radius of the chamfered portion 240 and the radius of the first chamfered surface 160 is less than 0.1 mm, stress is concentrated at this position, and the housing 100 is damaged when the battery 10 is dropped. When the difference between the radius of the chamfered portion 240 and the radius of the first chamfered surface 160 is greater than 2 mm, because the difference between the radius of the chamfered portion 240 and the radius of the first chamfered surface 160 is extremely large, fitting between the protection member 200 and the housing 100 is poor, and the protection member 200 is prone to wobbling within the housing 100.

Further, refer to FIG. 3. In some embodiments, a dimension of the protruding portion 220 in a length direction of the cell 300 is L4, and L4≥0.1 mm. L4 may be 0.2 mm, 0.3 mm, 0.4 mm, or the like. If L4 is less than 0.1 mm, the protruding portion 220 is too small to provide an adequate cushioning distance for effectively protecting the tab 700.

Further, refer to FIG. 4. The protection member 200 is further provided with a tab hole 260, a distance between the tab hole 260 and an edge of the protection member 200 in a thickness direction of the battery 10 is L5, and 0.2 mm≤L5≤2 mm. Specifically, two tab holes 260 may be provided for the positive tab and the negative tab to pass through respectively. A specific distance between each of the tab holes 260 and the edge of the protection member 200 may be the shortest distance from the respective tab hole 260 to the edge of the protection member 200 in the thickness direction of the battery 10. The tab hole 260 may be provided on the protruding portion 220 or the body portion 210. When L5 is less than 0.2 mm, and when the positive tab passes through the tab hole 260, because the tab hole 260 is close to the edge of the protection member 200, the positive tab may come into contact with the housing 100. When L5 is greater than 2 mm, the tab hole 260 excessively offsets from a middle position of the protection member 200, resulting in subsequent inconvenience of welding the positive tab to the terminal.

Further, in some embodiments, a length of the body portion 210 is greater than a length of the main body 600, and the length of the body portion 210 is less than a width of the storage cavity 110. Specifically, a difference between the length of the body portion 210 and the width of the storage cavity 110 is within 0.3 mm. If the length of the body portion 210 is excessively long, the body portion 210 cannot be placed into the storage cavity 110.

Further, in some embodiments, the first surface 120 of the housing 100 is further provided with a liquid injection port, where the liquid injection port is used for injecting electrolyte into the storage cavity 110. When the electrolyte is injected from the housing 100 into the storage cavity 110, a flow-through hole 250 may be provided in the body portion 210 or the protruding portion 220 to facilitate injection of the electrolyte, thereby facilitating filling of the electrolyte. The flow-through hole 250 may be elliptical or circular. When the flow-through hole 250 is circular, a diameter of the flow-through hole 250 is greater than a diameter of the liquid injection port. The diameter of the liquid injection port may range from 1 mm to 2 mm, and the diameter of the flow-through hole 250 may range from 2.5 mm to 3 mm. When the flow-through hole 250 is elliptical, a projection of the liquid injection port falls within a projection range of the flow-through hole 250 in the length direction of the cell 300.

Further, in some embodiments, the protection member 200 may be provided with a tab hole 260 for the tab 700 to pass through. A length of the tab hole 260 may be greater than a width of the tab 700, which may facilitate passage of the tab 700 through the tab hole 260. Specifically, the length of the tab hole 260 is L6, the width of the tab is L7, and 0.8 mm≤L6−L7<3 mm. If a difference between the length of the tab hole 260 and the width of the tab 700 is less than 0.8 mm, the manufacturing process becomes more difficult. If the difference between the length of the tab hole 260 and the width of the tab 700 is greater than 3 mm, strength of the protection member 200 is reduced due to the excessively large tab hole 260.

In some embodiments, an electronic device includes the battery 10 according to any one of the foregoing embodiments. Specifically, one side of a cell 300 abuts against a second surface 130 of a housing 100, the other side of the cell 300 abuts against a body portion 210, and a protruding portion 220 abuts against a first surface 120. In this way, the two sides of the cell 300 can directly or indirectly abut against the housing 100 by using a protection member 200. During a mechanical test, for example, a drop test, of the battery 10, movement space of the cell 300 within the housing 100 is limited. This can effectively prevent the tab 700 from being torn by the main body 600. Specifically, the battery 10 can exhibit high safety performance. Further, the electronic device including the battery 10 exhibits good safety performance.

Although embodiments of the present disclosure are described in detail above with reference to the accompanying drawings, the present disclosure is not limited to the foregoing embodiments, and various changes can be made within the knowledge scope of those having ordinary skills in the art without departing from the principle of the present disclosure. In addition, embodiments and features in the embodiments of the present disclosure may be mutually combined without conflict.

What is claimed is:

1. A battery, comprising:
a housing, comprising a storage cavity, wherein the housing comprises opposing first surface and second surface;
a terminal, connected to the first surface, wherein one end of the terminal protrudes from the housing;
a cover plate, connected to the housing;
a cell, disposed in the storage cavity, wherein the cell comprises a main body and a tab, two ends of the tab are respectively connected to the main body and the terminal, and a side of the main body facing away from the tab abuts against the second surface; and
a protection member, disposed between the first surface and the cell, wherein the protection member comprises a body portion and a protruding portion, the protruding portion is connected to the body portion and protrudes from the body portion, the body portion abuts against the cell, and the protruding portion abuts against the first surface.

2. The battery of claim 1, wherein a length of the protection member in a length direction of the cell is B1, and 1 mm≤B1≤4 mm.

3. The battery of claim 2, wherein the length of the protection member in the length direction of the cell is B1, and 1.55 mm≤B1≤3.55 mm.

4. The battery of claim 1, wherein the body portion has a first cavity, the protruding portion has a second cavity, and the first cavity and the second cavity are in communication with each other.

5. The battery of claim 4, wherein a projection of the body portion falls on a projection of the main body in a thickness direction of the protection member.

6. The battery of claim 4, wherein a thickness of the protection member is L1, and 50 μm≤L1≤500 μm.

7. The battery of claim 1, wherein a plurality of protruding portions are provided, and the plurality of protruding portions are arranged at intervals in a length direction of the body portion.

8. The battery of claim 1, wherein a material of the protection member is one of polyetheretherketone, polyimide, polyetheretherketone composite, thermoplastic elastomer, or polyphenylene sulfide.

9. The battery of claim 1, wherein the protection member is made of a material having a Shore hardness≤90 degrees.

10. The battery of claim 1, wherein the protruding portion has an abutment surface, and the abutment surface abuts against the first surface.

11. The battery of claim 1, wherein two protruding portions are provided, the two protruding portions and the body portion jointly define a groove, and the tab is partially disposed in the groove.

12. The battery of claim 1, wherein the housing further comprises a third surface, a fourth surface, a first chamfered surface, and a second chamfered surface, the third surface and the fourth surface are oppositely disposed, two ends of the first chamfered surface are connected to the third surface and the first surface respectively, and two ends of the second chamfered surface are connected to the fourth surface and the first surface respectively.

13. The battery of claim 12, wherein the first chamfered surface has a radius of L2, a chamfered portion is disposed at a connection between the body portion and the protruding portion, the chamfered portion has a radius of L3, and 0.1 mm≤L2−L3≤2 mm.

14. The battery of claim 1, wherein a dimension of the protruding portion in a length direction of the cell is L4, and L4≥0.1 mm.

15. The battery of claim 1, wherein the protection member is further provided with a tab hole, a distance between the tab hole and an edge of the protection member in a thickness direction of the battery is L5, and 0.2 mm≤L5≤2 mm.

16. An electronic device, comprising the battery of claim 1.
